(19) United States
(12) Patent Application Publication
(10) Pub. No.: US 2008/0241441 A1
(43) Pub. Date: Oct. 2, 2008

(54) OVERMOLDING OF A TUBE HEAD ON A SKIRT END TO GIVE A TUBE WITH A HIGH RESTITUTION RATE

(75) Inventors: Dominique CHASLIN, Chalons en Champagne (FR); Jacques LEBLAIS, Nantes (FR)

Correspondence Address: DENNISON, SCHULTZ & MACDONALD, 1727 KING STREET, SUITE 105, ALEXANDRIA, VA, 22314, US

(73) Assignee: ALCAN PACKAGING BEAUTY SERVICES, Gennevilliers (FR)

(21) Appl. No.: 11/863,309

(22) Filed: Sep. 28, 2007

(30) Foreign Application Priority Data
Mar. 27, 2007 (FR) 07/02221

(51) Int. Cl. B29D 22/00

(52) U.S. Cl. 428/34.1; 264/248; 264/313

(57) ABSTRACT

Manufacturing process for a flexible tube, in which a tubular blank is fitted around a punch so that an end portion of the tubular blank protrudes by a height H from the side wall of the punch; a die is brought up to the punch and the end portion is imprisoned in the cavity thus formed; plastic is injected into the cavity until it comes into contact with the end portion so that it is welded to the skirt, without any additional contribution of heat or matter. The impression of the die used is at a depth greater than the protruding height H of the end portion, and has a ring-shaped boss obstructing the flow of the plastic, the outer edge of the ring-shaped boss and the inner edge of the end portion being distant from each other by a value less than the average thickness e of the transverse wall.

### FIELD OF THE INVENTION

The invention relates to the field of flexible tubes that distribute creamy or pasty substances, typically cosmetic, food, medicinal, parapharmaceutical, etc. products. The flexible tubes concerned have a head made of plastic materials(s) and a cylindrical skirt (which may be axisymmetric or not) comprising substantially one or more plastic layers, possibly with a fine intermediate metal layer. The skirt is flexible so that it can become deformed as a result of pressure exerted, for example, by the hand, and so that some of the substance contained in the tube can be squeezed out of it. The invention more specifically relates to flexible tubes produced by injection overmolding of the tube head onto one end of the flexible skirt.

### DESCRIPTION OF RELATED ART

In general, a flexible tube is produced by assembling two separately manufactured parts: a cylindrical flexible skirt of a given length (typically 3 to 5 times the diameter) and a head including a neck with a dispensing orifice and a shoulder connecting said neck to the cylindrical skirt. The head made of plastic materials(s) can be molded separately then welded onto one end of the flexible skirt, but this can better be molded and welded autogenously to the skirt using either an injection molding technique (FR 1.097.707) or a technique involving molding by compression of an extruded blank (FR 1 324 471).

In both these techniques, the skirt is fixed around a punch, one of its ends slightly protruding from the end of the punch, said punch end being used as a mold to produce the internal surface of the tube head. In these two techniques, a die is placed opposite the end of the punch, the impression of this die defining the external surface of the shoulder and the neck. The main difference between these processes lies in the fact that, in the first case, the tools are initially held firmly one against the other before the plastic is injected, and, in the second case, the compression of an extruded blank is obtained by bringing them together.

In both cases, the end of the skirt protruding from the punch is imprisoned in the cavity defined by the end of the punch and the impression of the die. The plastic—as a result of the injection or the compression—comes in contact with the end of the skirt and, being at a higher temperature than their respective Vicat softening points, the plastics of the head and skirt are welded closely together without the need for any other heat or matter. After being briefly maintained under pressure (for a few seconds) and allowed to cool, the head, molded to the required dimensions, remains firmly welded to the skirt.

The present invention follows the technique of injection overmolding, which allows heads of complex shapes, such as those provided with hinged lids, to be obtained.

Known tubes have both the economic and ecological disadvantage of being difficult to completely empty of their contents, such that the consumer is dissatisfied at not being able to use all the substance contained in a tube which he has sometimes paid a lot of money for (this is the case with certain cosmetic creams). For the same reason, the citizen who is keen to preserve the environment is dissatisfied to see most of these substances that remain stuck inside the tube going off with it to the waste tip, thereby polluting the environment during waste storage and/or processing.

The purpose of the invention is to produce flexible tubes that are easy to empty completely, i.e. with a particularly high restitution rate, typically higher than 90%, or even 95%, whatever the shape and the geometrical structure of the head, i.e. a head with a substantially cylindrical neck provided with a dispensing orifice and a substantially tapered shoulder connecting the flexible skirt to said neck, or a head with a transverse top wall, substantially perpendicular to the axis of the tube, provided with a dispensing orifice and possibly connected to a hinged lid, said lid being designed to seal said dispensing orifice.

The conventional tube head, comprising a substantially cylindrical neck and a substantially tapered shoulder, has for long been molded onto a skirt end. As of the fifties, it was recommended to neck the skirt end before carrying out the injection molding, the reduction in diameter of said skirt end being imposed by the impression of the mold itself. As of French patent FR 1 136 438, published in 1956, the junction between the molded plastic and the skirt is described thus (claim 1): the head comprises “a narrow marginal band [ . . . ] which is covered by a marginal narrow band of one of the ends [of the skirt], extending both onto part of the [skirt] and onto part of the top [of the shoulder], and with which it is fused, in order to form a junction area describing a continuous, circumferential part [ . . . ], the narrow marginal band of the [skirt] extending partially onto the top face of the head.” Such a fused surface makes it possible to obtain “a strong joint by continuous amalgamation on [the] edge as well as vertically” and “contributes to resistance to axial strain, and solidifies the container at a vital point, by preventing the container from being bent during filling and handling”.

Such a spatial layout, conferring real solidity to the edge of the shoulder, was systematically chosen in almost all manufacturing processes for flexible tubes involving injection overmolding of the head onto the skirt. Such solidity also leads to great stiffness of the shoulder edge so that the tube has a poor restitution rate. Recently, attempts to make the shoulder more flexible, and therefore easier to crush, have been described in patent applications JP 2001 287755 and WO 2006/089434.

However, these techniques can apply only to a conventional tube head, with a substantially tapered shoulder. To produce flat tube heads provided with a hinged lid such as those disclosed in French design patent 98 7300 published as numbers 535.807 to 535.814 (L'Oréal), the applicant proposed a solution in patent FR 2 811 967 which involves producing transverse flat tube heads provided with a large diameter orifice surrounded by a circular cylindrical wall extending towards the inside of the tube, designed to irreversibly fix a rigid capping device comprising a base and a hinged lid. The great stiffness of the assembly produced in this way does not make it possible to obtain a satisfactory restitution rate, even after introducing cavities worked into the flat head, the bottom of which forms kinds of “internal” shoulders.

The applicant therefore attempted to develop a process which makes it possible to obtain a flexible tube having a high restitution rate, typically higher than 90%, or even 95%, specifically a process allowing the manufacture of a tube whose head has a transverse top wall connected to a flip-top cap having a hinged lid but, because of the economic requirements imposed by the use of high-output machines, which also makes it possible to manufacture tubes with more conventional head shapes.

### SUMMARY OF THE INVENTION

A first purpose of the invention is a manufacturing process for a flexible tube comprising a substantially cylindrical flexible skirt and a head including a transverse wall, typically flat or tapered, with an average thickness e and provided with a dispensing orifice, said process including the following steps:
a) procuring a substantially cylindrical tubular blank of thickness E and comprising at least one polymeric plastic on its inside surface;
b) fitting said tubular blank around a substantially cylindrical tool, called punch, with an axis and an orthogonal section whose external contour fits to the shape of the skirt to be produced, positioned in such a way that a portion of the end of said tubular blank, called end portion, protrudes by a height H from the side wall of said punch;
c) bringing up a die to said punch so that once the die and the punch have been brought into contact, the union of the punch and the die impressions forms a cavity having the shape of the head to be obtained, the end portion of the tubular blank being imprisoned in said impression;
d) bringing said punch and said die into contact;
e) injecting molten plastic into said cavity in order to obtain said head, plastic being injected in at least one point of the central part of the cavity so that it runs out into said cavity in a globally centrifugal, radial movement, to come into contact with the end portion of the tubular blank, and so that it is welded with at least the plastic of the inside face of said end portion, without any further heat or matter being contributed;
wherein the die used in steps c) to e) has an impression comprising a bottom and a side wall having the following geometrical characteristics:
i) on the edge, the side wall of the impression opposite the punch remains substantially axial;
ii) the bottom of the impression near the tubular blank is at a depth greater than the protruding height H of the end portion, so that said end portion does not come up against the bottom of the die impression and the injected plastic can run out into a ring-shaped edge area located above the top section of said end portion (conventional orientation: the tube is offered up with the head at the top);
iii) the bottom of the die has a ring-shaped boss which obstructs the flow of the plastic towards said ring-shaped edge area, the outer edge of said ring-shaped boss and the inner edge said end portion being distant from one another by an amount lower than the average thickness e of said transverse wall, preferably less than e/2.

In the context of this invention, the term “cylinder” is used to denote any surface generated by a line which follows a closed curve while remaining parallel to itself. The flexible skirt is therefore said to be substantially cylindrical in the sense that it can have a cylindrical shape (the orthogonal section is a closed curve), or even a prismatic shape (the prism is a special case of the cylinder in which the curve is a polygon), preferably, in this latter case, with rounded angles. In practice, the blank has a substantially circular orthogonal section at present and, after being fitted around the punch, it has the shape of the future skirt, i.e. as a general rule, a circular or elliptic orthogonal section depending on the shape imposed by said punch.

The transverse wall of the head may be flat, in general extending perpendicular to the axis of the skirt. It may also take the form of a tapered shoulder, for example connecting the skirt to a neck provided with a dispensing orifice. This head can be inscribed inside the space defined by the skirt, but it can also protrude sideways from said skirt, for example when provided with a hinged lid. It is provided with a centered dispensing orifice, i.e. located around the axis of the skirt, or a non-centered one, in particular for heads provided with a hinged lid. In the following, we will take central impression, central cavity or central part to mean the respective portions of the die impression, the molding cavity and the head which are around the punch.

According to the invention, a substantially cylindrical blank is provided to form the skirt. This blank can be obtained from a cylindrical sleeve cut to the desired length. The sleeve itself is obtained by extrusion or rolling-welding. The blank is fitted onto the punch so that it covers the side wall of the punch without any play, at least at the level of the top part of said punch, over a height typically close to the value of the diameter of said punch

The die can be made up of several parts, with at least a central die designed to be placed around the punch, so that after the die and the punch come into contact with each other, the union of the punch and the die impressions causes a cavity to be formed having the shape of the central part of the head to be obtained: shoulder and neck for a conventional tube head, or base of a head with a hinged lid, the cap itself being obtained by molding in a side cavity worked into the die.

According to the invention, the head is molded by injection of a plastic, typically a polyolefin, preferably a high-density polyethylene, or a polypropylene. In particular, the central part of the head (shoulder and neck for a conventional tube head or base of a head with a hinged lid) is made by injecting the plastic through at least one channel, outletting close to the axis of the punch, so that the plastic runs out into the cavity in a globally centrifugal, radial movement to come into contact with the end portion of the tubular blank, by exerting a substantially radial pressure on the internal side surface of said end portion.

Preferably, in particular when the head has a hinged cover, at least the external layer of the head is molded from a polypropylene, a polypropylene copolymer or terpolymer, or a polypropylene polymixture, and the skirt consists of a multi-layer, whose outside layer, turned towards the inside, includes polypropylene, typically a statistical polypropylene copolymer with a weight proportion of up to 50% of one or more aliphatic polyolefins without any functional group. Other combinations of materials are possible, for example:

1) a skirt with an outside layer turned towards the inside made of polyethylene and a head, possibly provided with a hinged lid, molded with at least one external layer made from a mixture of a polypropylene and a polyethylene obtained by metallocene catalysis;

2) a skirt with an outside layer turned towards the inside made of polyethylene obtained by metallocene catalysis and a head, possibly provided with a hinged lid, molded with at least one external layer including polypropylene obtained by metallocene catalysis.

In order for it to be closely welded to the plastic of the inner face of said end portion, without any additional contribution of heat or matter, the die used according to the invention has, in the neighborhood of the punch, a special design. It has an impression with a bottom and a side wall with the following geometrical characteristics:
i) on the edge, the side wall of the impression opposite the punch remains substantially axial;
ii) at the edge the impression it has a depth greater than the protruding height H of said end portion, so that said end portion does not come up against the bottom of said die impression and the injected plastic can run out into a ring-shaped edge area located above the top section of said end portion;
iii) the bottom of the die has a ring-shaped boss which obstructs and delays the flow of the plastic towards said ring-shaped edge area, the outer edge of said ring-shaped boss and the inner edge of said end portion being distant from one another by an amount lower than the average thickness e of said transverse wall, preferably lower than e/2. Before reaching this ring-shaped edge zone, the plastic, whose flow direction is globally radial centrifugal, must cross the throttling point resulting from the presence of said boss in the die impression. Typically, the outer edge of the ring-shaped boss is substantially at the same level as the top section of the end portion of the tubular blank, and preferably slightly below, the variation in level K being typically lower than half the average thickness e of the transverse wall, and at a radial distance J close to half the average thickness e of the transverse wall, preferably ranging between e/4 and 3e/4

The fact that the plastic has to cross the obstacle as it flows towards the ring-shaped edge zone of the cavity located above the tubular blank causes a throttling which results in a locally increased shearing within the material flow and in an increased shearing stress imposed on the top of the skirt end portion, thereby facilitating the deformation and the flow of the material of the end portion. The result of this is a local homogeneous mixture of the plastics of the head and skirt. Parameters J and K are to be determined according to concrete cases, depending on the design and the materials used. Preferably, the top of the ring boss is slightly lower than the top section of the tubular blank (conventional orientation: the tube is offered up with the head at the top).

Throttling also involves a local increase in pressure against the side wall of the end portion, so that said end portion is strongly pressed against the side wall of the die, thus decreasing the risks of uncontrolled flow of the plastic of the head against the outer side wall of the skirt. The ring-shaped edge zone of the cavity, located above the summit section of the tubular blank, can therefore be connected to a side cavity, for example to form a hinged lid, without there being any risk of burr forming at the level of the hinge connecting the base to the cap.

The close contact between the plastic of the head and that of the skirt, which is achieved on the inner face of the skirt end portion, is supplemented by a homogeneous mixture of said plastics in the ring-shaped edge zone of the cavity which is located above the tubular blank. This zone can be a small one, with a radial width corresponding to E+J, typically lower than E+e/2. By assigning to this zone a height C at least equal to e/4 and close to, or lower than the thickness e of the transverse wall, the welding between head and tube has a slight oversize, with a top ring-shaped edge portion having mechanical behavior similar to that of the skirt. The volume occupied by this top ring-shaped edge portion can be reduced by making an oblique wall at the edge of the annular boss.

In previously-known techniques, the end portion of the tubular blank was necked, the reduction in diameter of said skirt end being imposed by the impression of the die itself. Here, the side wall of the die impression follows the shape of the tubular sleeve and does not impose any necking to the end portion. In previously-known techniques, the plastic ran out in a basically radial direction into a tapered cavity and flowed tangentially at the necked part of the end portion. Here, the plastic flows frontally against the inner face of the skirt end portion, and part of said plastic can escape by the means of a throttled zone above the tubular blank. In previously-known techniques, it was necessary to mold a shoulder with a substantially oversized thickness upstream and at the level of the necked part of the end portion, and this extra thickness caused significant stiffening of the edge of the shoulder. The process according to the invention means that now a thinner head can be made without significant extra thickness at the level of the weld. The edge therefore becomes particularly flexible, so that it is possible, by simple manual pressure on said edge of the head to extract the substance which formerly remained stuck to the wall of the tube at this point. The result of this is a substantial improvement the restitution rate.

Preferably, in order to ensure proper weld good quality between the head and the skirt, the edge of the punch head is chamfered so as to make the height of the contact surface between head and skirt significantly greater—typically more than twice as great, and preferably more than three times as great—as the average thickness e of the transverse wall of the head. The edge of the punch head can to advantage be chamfered in order to increase the contact surface between head and skirt. Typically, the angle of the chamfer to the vertical is between 30° and 60° and the height of the chamfer is about double the average thickness of the head.

The die and the punch are arranged to advantage so that their side walls, after said die and said punch are put into contact with each other, are in the vicinity of the end portion of the tubular blank, distant from each other by a value slightly lower than the thickness of the tubular blank, thereby typically producing a tightening of 0.1 mm, so that said tubular blank is firmly held at a height ranging from between one and five times the protruding height H of said end portion.

In a preferred method, to facilitate the installation of the die and to avoid damaging the end portion of the tubular blank, the die comprises three parts: a top part comprising at least the central impression which works in tandem with the top wall of the punch to form the central part of the head, and two lower parts, mobile in relation to each other, sliding in a direction passing through the axis, and which, when they come together, make it possible to hold the top end of the tubular blank up against the punch. Once brought together, the two lower parts are assembled to the top part by means of a conical fitting.

Another embodiment of the invention consists in performing the overmolding not by injection but by compression. In this case, the die includes a top part that has at least the central impression which works in tandem with the top wall of the punch to form the central part of the head and at least a lower part designed to hold the top end of the tubular blank up against the punch before compression starts. Preferably, as described previously, this lower part includes two lower parts, mobile in relation to each other, sliding in a direction passing through the axis, and which, when they come together, makes it possible to hold the top end of the tubular blank up against the punch. Stages d) and e) of the injection process are then replaced by the following stages:

d′) the top end of the tubular blank is held up against the punch using the lower part of the die;

e′) a blank is laid down using at least one molten plastic;

f′) the punch and the top part of the die are brought together until said punch and said top part of the die come into contact with one another;

The blank is made, for example, by extrusion or coextrusion of a thick, full or tubular extrudate, which is then sheared to obtain a nut or ring which is then deposited in the air-gap between the die and the punch, i.e. in the impression of the top part of the die (the tube is then made “upside down”) or on the top face of the punch (the tube is then made “right way up”). This process can also be used to produce a head with a hinged lid: in this case, a second blank is deposited in the air-gap corresponding to the side cavity designed to mould the cap and the hinge. The respective volumes of the first and the second blank are defined so that the parts thus molded are welded at the edge of the ring-shaped edge zone or within it.

Another purpose of the invention is a flexible tube that can be produced using said process, comprising a substantially cylindrical flexible skirt and a head including a transverse wall, typically flat or tapered, provided with a dispensing orifice and with a weld zone between head and tube that has a top ring-shaped edge portion with a radial width lower than the sum of the thickness of the skirt and the average thickness of the transverse wall, and a height C at least equal to a quarter of the average thickness e of said transverse wall. Said top ring-shaped edge portion advantageously has a height C that is close to, or lower than the average thickness e said transverse wall.

### BRIEF DESCRIPTION OF THE DRAWINGS

FIG. 1 is an enlargement of the detail defined by a circle marked “D” on the illustration in FIG. 5. This FIG. 1 shows the tubular blank.

FIG. 2 shows one example of an embodiment of the invention, the tube head having a top transverse wall that is globally flat.

FIG. 3 shows a second example of an embodiment of the invention, the head of the tube having a top transverse wall that is globally flat connected to a hinged lid, molded unfolded to 1800 in relation to said top wall.

FIG. 4 shows the molding tools used to produce the tube in FIG. 3, before the punch and the die are put into contact with each other to produce the molding impression.

FIG. 5 shows the molding tools used to produce the tube in FIG. 3, after the different parts of the die are brought together and the die put into contact with the punch. In this figure, as in the previous one, the tubular blank is not shown.

### DESCRIPTION OF PARTICULAR EMBODIMENTS OF THE INVENTION

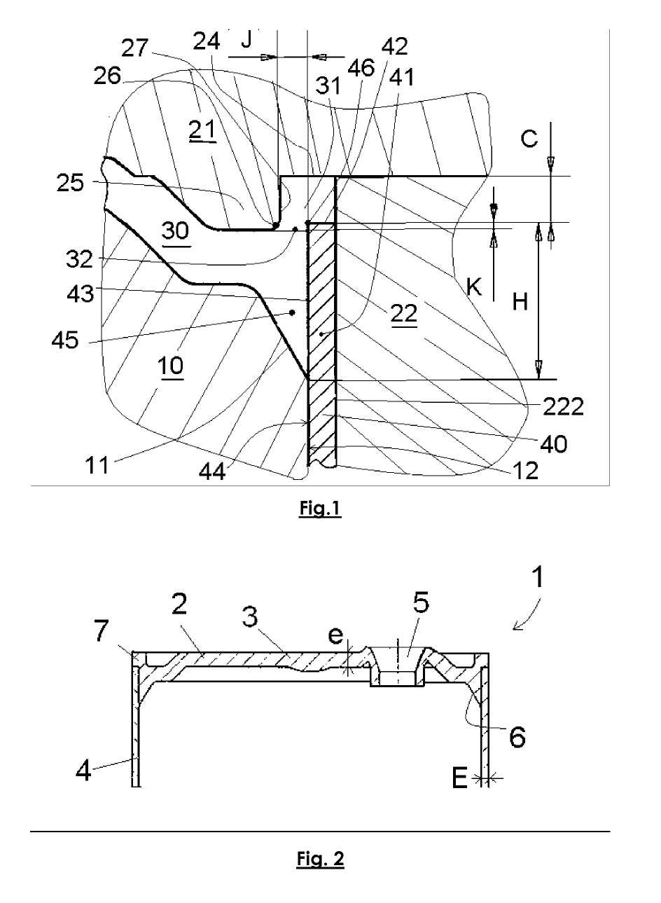

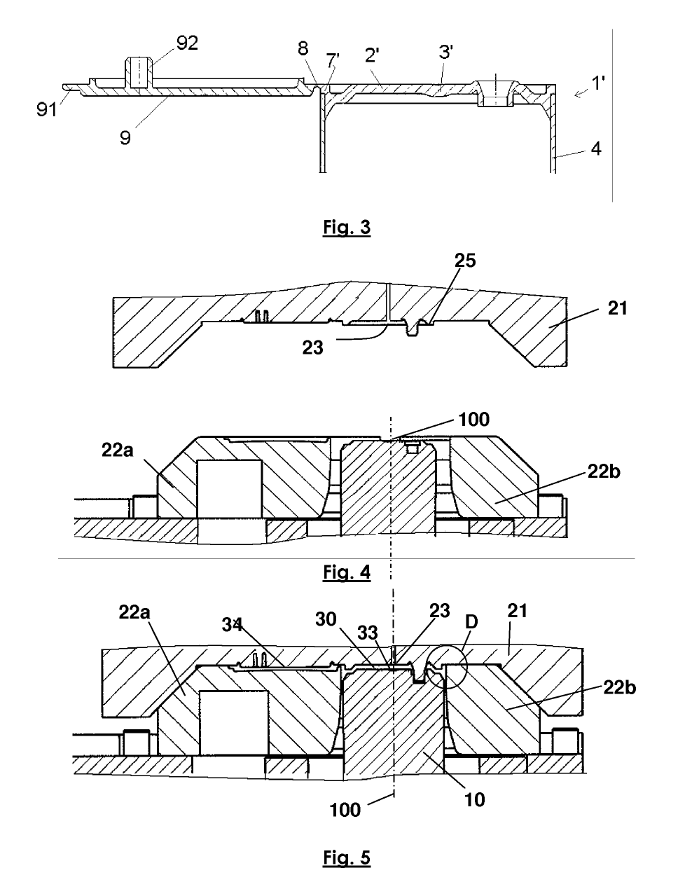

### EXAMPLE 1 (FIGS. 1, 2 AND RIGHT-HAND HALF OF FIG. 5)

The flexible tube 1 to be produced includes a flexible, cylindrical skirt 4 of thickness E=0.400 mm and a head 2 including a flat, transverse wall 3, extending in a plane orthogonal to the axis of the skirt and provided with a dispensing orifice 5. Thanks to the process according to the invention, the thickness e of said transverse wall can be low, typically in the order of one millimeter.

To produce this flexible tube, a tubular blank 40 is fixed around a punch 10 so that a end portion 41 of said tubular blank protrudes by a height H=2 mm from the side wall 12 of said punch. A die (21+22) is brought up to the punch 10 and the portion of the end 41 is imprisoned in cavity 30, formed as the impression of the die (21+22) and the top face of the punch meet. Plastic is injected into said cavity until it comes into contact with the end portion 41 so that it is welded with the skirt, without any additional contribution of heat or matter.

The side wall 222 of the central impression is substantially vertical, so that the end portion 41 does not undergo any significant necking. The impression of the die is at a depth greater than the protruding height H of the end portion 41, and has a ring-shaped boss 25 obstructing the flow of the plastic. The top 27 of the ring-shaped boss 25 is substantially at the same level as the top section 42 of the end portion 41, slightly below (difference in level K=0.1 mm). The outer edge 26 of the boss 25 is at 0.5 mm from the inner edge 46 of the tubular blank 40 (radial distance J).

The head is molded by injecting a high-density polyethylene. It is made by injecting the plastic through a channel 23 leading into cavity 30 at the level of the axis 100 of punch 10, so that the molten material runs out into the cavity with a globally centrifugal radial movement to arrive in contact with the end portion 41, exerting a practically radial pressure on the inner side surface 43 of said end portion.

ii) at the edge, the impression of the die 21+22 has a depth greater than the protruding height H of the end portion 41 so that said end portion does not come up against the bottom of the impression and the injected plastic can run out sideways above the top section 42 of said end portion. The plastic which flew in a globally radial centrifugal direction before reaching this zone must cross an obstacle formed by the ring-shaped boss 25. The peripheral edge 26 of the ring-shaped boss 25 is a few tenths of a millimeter below the level of the top section 42 of the end portion. K is between 0.1 and 0.3 mm. The radial distance J is 0.5 mm.

The fact that the plastic has to cross the obstacle as it flows towards the ring-shaped edge zone 31 results in throttling 32 which causes a local increase in shearing within the material flow and an increase in the shearing stress imposed on the top of the end portion 41 of the tubular blank, thereby facilitating the deformation and the flow of the material of the said end portion.

The ring-shaped edge zone 31 of the cavity 30 which is located above the tubular blank 41 has a radial width of about 0.8 mm and a height C close to 1 mm This means that the weld between head and tube has a slight extra thickness, with a top ring-shaped edge zone having mechanical behavior similar to that of the skirt. Here, the edge wall 27 of the boss is vertical. The volume occupied by the ring-shaped edge portion 31 could have been decreased, making this wall 27 oblique.

The edge 11 of the punch head 10 is chamfered in order to increase the contact surface between head and skirt. The angle of the chamfer to the vertical is 40° and the height of the chamfer is about double the average thickness e of the head.

During injection, the plastic arrives in the cavity at the level of the injection point 23 located close to axis 100, runs out radially until it comes up against the inner face 43 of the end portion 41, fills the hollow 45 defined by the chamfered zone 11 of punch 10 and the end portion 41 and then, as pressure rises locally, manages to pass the throttling zone 32 to fill the ring-shaped edge zone 31. The flexible tube produced in this way has a weld zone between head and tube with a characteristic shape: it has a top ring-shaped edge portion 7 with a radial width of about 0.8 mm and a height C of about one millimeter.

With such a geometrical weld configuration between the head and the skirt, the edge of the tube head, which is not very stiff, is practically as easy to compress by hand as the rest of the skirt, which makes it possible to increase the restitution rate of the tube to a significant degree.

### EXAMPLE 2 (FIG. 1, FIGS. 3 to 5)

The flexible tube 1′ to be produced includes a cylindrical flexible skirt 4 of elliptic orthogonal section and thickness 0.400 mm, together with a head 2′ including a flat transverse wall 3′, extending in an orthogonal plane to the axis of the skirt, provided with a dispensing orifice and connected to a lid 9 via a hinge 8. The lid is provided with a protuberance 91 helping to hold the lid when it is in closed position It is also provided with a leak-tight skirt 92 which goes inside the dispensing orifice and seals this when lid 9 is closed.

The forming process is identical to that previously described. The die used includes a side cavity 34 making it possible to produce the hinged lid 9. The side cavity 34 is connected to the central cavity 33 by a channel whose impression makes it possible to produce the hinge.

To make it easier to fit the die and to avoid damaging the end portion of the tubular blank, the die consists of three parts: a top part 21 comprising at least the central impression which works in tandem with the top wall of the punch to form the central part 3′ of the head, and two lower parts 22a and 22b that can be slid in a direction perpendicular to the axis 100 and passing through it which, when they come together, make it possible to hold the top end of the tubular blank 40 up against the punch. Once brought together, the two lower parts are assembled to the top part by means of a conical fitting.

The die 21+22a+22b and punch 10 are arranged so that their side walls 12 and 222 are, once said die and said punch have been brought into contact with each other in the vicinity of the end portion 41 of the tubular blank 40, distant by 0.3 mm from each other, so that said tubular blank is firmly held at a height of at least 10 mm.

The whole of the head (base 3′ and lid 9) is produced by injection of high-density polyethylene. The plastic arrives in the cavity at the level of the injection point 23 located close to axis 100, runs out radially until it comes up against the inner face 43 of the end portion 41, fills the hollow 45 defined by the chamfered zone 11 of punch 10 and the end portion 41 and then, as pressure rises locally, manages to pass the throttling zone 32 to fill the ring-shaped edge zone 31 to form a top ring-shaped portion of the weld zone. At the level of the hinge, a duct allows the plastic to move into the side cavity to form the lid 9.

An injection gate can also be introduced at the level of the lid to decrease the injection time or to make a two-compound molding in order to obtain a particular esthetic effect (two-tone head), a different feel, or to obtain an additional technical function.

What is claimed is:

1. A manufacturing process for a flexible tube comprising a substantially cylindrical flexible skirt and a head comprising a transverse wall, typically flat or tapered, with an average thickness e and provided with a dispensing orifice, said process including the following steps:
a) procuring a substantially cylindrical tubular blank of thickness E and comprising at least one polymeric plastic on its inside surface,
b) fitting said tubular blank around a substantially cylindrical tool, called a punch, with an axis and an orthogonal section whose external contour fits to the shape of the inner face of said tubular blank, positioned in such a way that an end portion of said tubular blank protrudes by a height H from the side wall of said punch;
c) bringing up a die to said punch so that once the die and the punch have been brought into contact, the union of the punch and the die impressions forms a cavity having the shape of the head to be obtained, said end portion being imprisoned in said cavity;
d) bringing said punch and said die into contact; and
e) injecting molten plastic into said cavity in order to obtain said head, plastic being injected in at least one point of the central part of the cavity so that it runs out into said cavity in a globally centrifugal, radial movement, to come into contact with said end portion, and so that it is welded with the plastic of the inside face of said end portion, without any further heat or matter being contributed;
wherein the die used in steps c) to e) has an impression comprising a bottom and a side wall having the following geometrical characteristics:
i) on the edge, the side wall of the impression opposite the punch remains substantially axial;
ii) the bottom of the impression near the tubular blank is at a depth greater than the protruding height H of the end portion of the tubular blank, so that said end portion does not come up against the bottom of the die impression and the injected plastic can run out into a ring-shaped edge area located above the top section of said end portion;
iii) the bottom of the die has a ring-shaped boss which obstructs the flow of the plastic towards said ring-shaped edge area, the outer edge of said ring-shaped boss and the inner edge of said end portion being distant from one another by an amount lower than the average thickness e of said transverse wall, preferably less than e/2.

2. Manufacturing process for a flexible tube according to claim 1, wherein the top of the ring-shaped boss is slightly lower than the top section of the end portion of the tubular blank.

3. Manufacturing process for a flexible tube according to claim 1, wherein the variation in level (K) is lower than half the average thickness e of the transverse wall and wherein the radial distance (J) between the outer edge of said boss and the inner edge of said end portion is between e/4 and 3e/4.

4. Manufacturing process for a flexible tube according to claim 1, wherein the peripheral zone of the cavity which is located above the tubular blank has a height C that is greater than e/4 and close to, or lower than thickness e of said transverse wall.

5. Manufacturing process for a flexible tube according to claim 1, wherein a punch is used, with a head whose edge is chamfered in order to make the height of the contact surface between head and skirt at least twice, and preferably at least three times, greater than the average thickness e of the transverse wall of the head.

6. Manufacturing process for a flexible tube according to claim 5, wherein the angle of the chamfer to the vertical is between 30° and 60° and the height of the chamfer is about double the average thickness of the head.

7. Manufacturing process for a flexible tube according to claim 1, wherein a die and a punch are used, which are arranged so that their side walls, after said die and said punch are put into contact with each other, in the vicinity of the end portion of the tubular blank, are distant from each other by a value slightly lower than the thickness of the tubular blank, thereby typically producing a tightening of 0.1 mm, so that said tubular blank is firmly held at a height ranging from between one and five times the protruding height H of said end portion.

8. Manufacturing process for a flexible tube according to claim 1, wherein a die is used, which comprises three parts: a top part comprising at least the impression which works in tandem with the top wall of the punch to form the central part of the cavity, and two lower parts sliding along a diameter, and which, when they come together, make it possible to hold the top end of the tubular blank up against the punch.

9. A manufacturing process for a flexible tube comprising a substantially cylindrical flexible skirt and a head comprising a transverse wall, typically flat or tapered, with an average thickness e and provided with a dispensing orifice, said process including the following steps:
a) procuring a substantially cylindrical tubular blank of thickness E and comprising at least one polymeric plastic on its inside surface,
b) fitting said tubular blank around a substantially cylindrical tool, called a punch, with an axis and an orthogonal section whose external contour fits to the shape of the inner face of said tubular blank, positioned in such a way that an end portion of said tubular blank protrudes by a height H from the side wall of said punch;
c) bringing up a die to said punch so that once the die and the punch have been brought into contact, the union of the punch and the die impressions forms a cavity having the shape of the head to be obtained, said end portion being imprisoned in said cavity;
d) holding up the top end of the tubular blank against the punch using the lower part of the die;
e) laying down a blank using at least one molten plastic; and
f) bringing together the punch and the top part of the die until they come into contact with one another;
wherein said die includes a top part that has at least the central impression which works in tandem with the top wall of the punch to form the central part of the head and at least one lower part designed to hold the top end of the tubular blank up against the punch.

10. Manufacturing process for a flexible tube according to claim 9, wherein said blank is produced by extrusion or coextrusion of a thick full or tubular extrudate, which is then sheared to obtain a nut or a ring which is then deposited either in the impression of the upper part of the die or on the top wall of the punch.

11. Manufacturing process for a flexible tube according to claim 9, wherein the head of said tube includes a hinged lid and in which a second blank is deposited in the air-gap corresponding to the side cavity designed to mould the cap and the hinge, the respective volumes of the first and the second blank being defined so that the welding of the parts molded in this way is carried out at the edge or within the ring-shaped edge zone.

12. A flexible tube comprising a substantially cylindrical flexible skirt and a head including a transverse wall, typically flat or tapered and provided with a dispensing orifice wherein the weld zone between the head and the skirt has a top ring-shaped edge portion having a radial width lower than the sum the thickness E of the skirt and the average thickness e of the transverse wall and a height C at least equal to a quarter of the average thickness e of said transverse wall.

13. A flexible tube according to claim 12, wherein the height C of said top ring-shaped edge portion is close to, or lower than the average thickness e of said transverse wall.
